(19) United States
(12) Patent Application Publication
(10) Pub. No.: US 2017/0237701 A1
(43) Pub. Date: Aug. 17, 2017

(54) System and Method for Improved Social Media Aggregation and Notification

(71) Applicants: Roger Safont, Tampa, FL (US); John Jassy, Tampa, FL (US)

(72) Inventors: Roger Safont, Tampa, FL (US); John Jassy, Tampa, FL (US)

(21) Appl. No.: 15/433,439

(22) Filed: Feb. 15, 2017

Related U.S. Application Data
(63) Continuation of application No. 62/295,189, filed on Feb. 15, 2016.

(51) Int. Cl. H04L 12/58; G06F 17/30; H04L 29/08

(52) U.S. Cl. CPC H04L 51/32; H04L 51/04; H04L 67/306; G06F 17/30312; G06F 17/30353; G06F 17/30595

(57) ABSTRACT

A method for collecting and analyzing data related to Social Media Websites and making the results of the collected and analyzed data available to Social Media Candidate through the constant crawling of Social Media Websites, aggregating new updates, and providing the new updates to Social Media Candidates in a single deliverable form customizable by the Social Media Candidate for a given followee.

### RELATED APPLICATION DATA

This application claims priority to U.S. Provisional Patent Application Ser. No. 62/295,189, filed Feb. 15, 2016 entitled “System and Method for Improved Social Media Aggregation and Notification,” the contents of which are fully incorporated by reference herein for all purposes.

### BACKGROUND OF THE INVENTION

Field of the Invention

This invention relates to a method for providing candidates (“Social Media Candidate”) who use online social media services, specifically in the field of celebrity or social media profile related websites (“Social Media Website”), with a means of collecting and analyzing data from various social media websites, and notifying the Social Media Candidate of the data.

Background of the Invention

Social media dominates the Internet in the modern era. Services such as Facebook, Instagram, Twitter, Tinder, Bumble, Pinterest, LinkedIn, Google+, YouTube, and a host of other social media providers allow countless people to share, link, like, and otherwise connect with other people in the world. With so many online services providing updates, it is getting harder and harder to keep up with celebrities, companies, or the other important people in a person's life. A Social Media Candidate desiring to be constantly connected to one of their favorite celebrities, for example, would need to have an account with each social media platform with which the celebrity participates and check each social media platform individually for an update when there may or may not be one, resulting in the individual reading old updates. It is not presently possible for a Social Media Candidate to keep up with the constant stream of social media in today's society. Therefore, there exists a need for a system and method for aggregating social media content for a user such that they can be kept abreast of updates from a plurality of social media websites in a given timeframe.

### SUMMARY OF THE INVENTION

For purposes of summarizing this invention, the present invention is directed to a method for collecting and analyzing data related to Social Media Websites and making the results of the collected and analyzed data available to Social Media Candidate through the constant crawling of Social Media Websites, aggregating new updates, and providing the new updates to Social Media Candidates in a deliverable form customizable by the Social Media Candidate.

It is, therefore, a principle object of this invention to provide a system and method for aggregating social media data in the form of social media updates into a single deliverable form for a particular user based on the user's preferences.

It is another object of this invention to provide a system and method for actively patrolling the Internet for new posts/tweets/updates and forwarding those posts/tweets/updates to a central database.

It is another object of this invention to periodically inform a user of an object of attention's activity on social media.

In accordance with these and other objects, the invention is directed towards a system and method for aggregating social media data that has never been achieved heretofore.

In general, the system and method of the preferred embodiment comprises a periodic check against recent updates, querying the cloud, i.e., each social media website, and, if a new post is detected, update the local database. Users who are subscribed to the local database and who choose a particular individual to follow whose activities are stored in the local database are then notified of the recent social media activity of their chosen followee. The user may be notified in a pre-selected manner, for instance via an email, text message, or other communications message.

The resulting notification to the user centralizes the social media activity of the followee into an easy-to-read report, for example as a web page, that prevents the user from having to visit multiple social media websites.

The system and method disclosed herein results in a product which is completely unexpected and dramatically superior to what conventional wisdom in the field would predict.

### BRIEF DESCRIPTION OF THE DRAWINGS

For a fuller understanding of the nature and objects of the invention, reference should be had to the following detailed description taken in connection with the accompanying drawings in which:

FIG. 1 is a view of the first step of the system and method showing the wakeup procedure.

FIG. 2 is a view of the second step of the system and method showing the social media query procedure.

FIG. 3 is a view of the third step of the system and method showing the data save procedure.

FIG. 4 is a view of the fourth step of the system and method showing the local database query procedure.

FIG. 5 is a view of the fifth step of the system and method showing the notification procedure.

Similar reference characters refer to similar parts throughout the several views of the drawings.

### DETAILED DESCRIPTION OF THE PREFERRED EMBODIMENT

FIG. 1 shows the first step of the system and method. In step one, the local server 12 contacts the local database 10. The terms “local database” and “local server” mean a database and server under the control of the service running the described system and method. The local database may be a separate service than the local server, with the expectation that the local server can communicate with the local database. Preferably, this contact happens once a minute for constant updating but may be more or less frequent depending on the preference of the Social Media Candidate. The contact comprises a query for Social Media Candidates. The local database stores information concerning the celebrities or other social media personalities that are followed under the system. The local database may include an idenfier for the celebrity and one or more social media feeds or links associated with that celebrity.

For each social media feed, the local database will also store information to determine the last update provided at that social media feed. For example, the local database may store an entry for the link for a Facebook feed, and associated with that link the last update the system is aware of in connection with that Facebook feed.

The local server 12 continually queries the local database 10 for a list of celebrities to search for. In order to determine whether a Social Media Candidate is in need of an update, the local database 10 and local server 12 determine whether a query about a Social Media Candidate's followee 16 will return new data by comparing the followee's 16 last update to the last notification provided to the Social Media Candidate. If the last update was not included in the last notification, it will be considered new data. A followee is defined as a user of interest to the Social Media Candidate, generally a celebrity or well-known person but may also include friends and family.

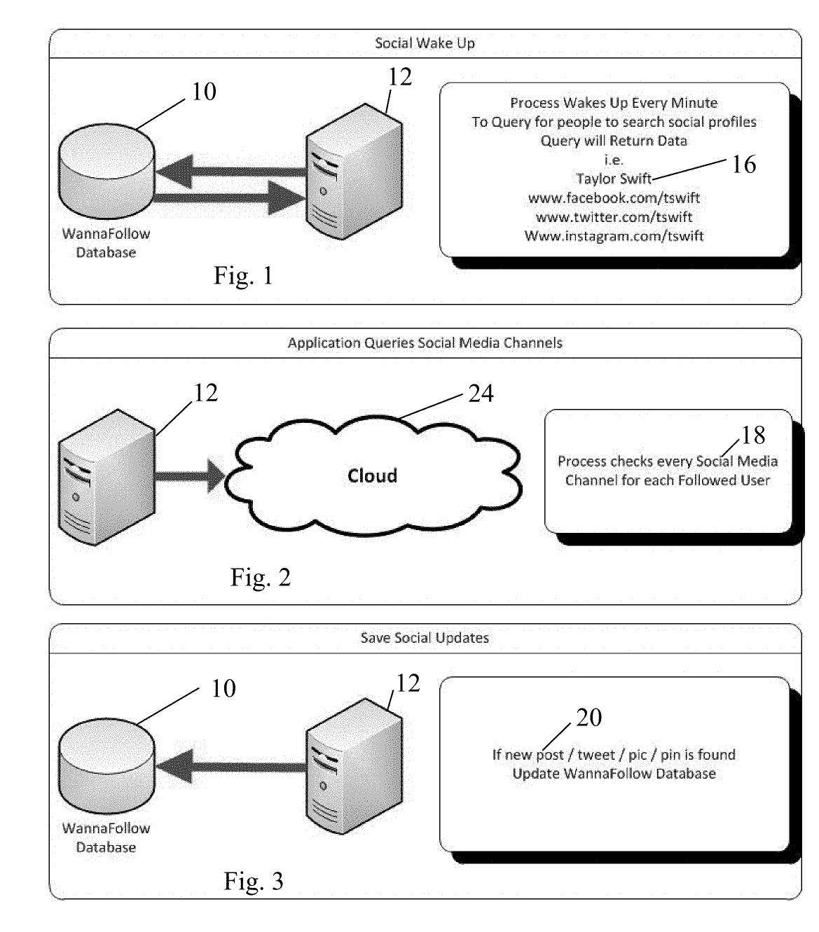

FIG. 2 shows the second step of the system and method. In step two, the local server 12 contacts each and every social media channel 18 for each followee 16 using the cloud 24. These social media channels 18 may include, but are not limited to, websites such as Facebook, Twitter, and Instagram. The local server 12 can use any and all methods of searching to complete its task both known and unknown but preferred method is through the use of web crawlers similar to how Internet analytics engines populate their search results.

FIG. 3 shows the third step of the system and method. In step three, if a new post 20 associated with a followee 16 is found during the search being performed by the local server 12, the new post 20 is collected by the local server 12 and pushed to the local database 10 for storage. The local database 10 is then considered “updated” with new data about the followee 16.

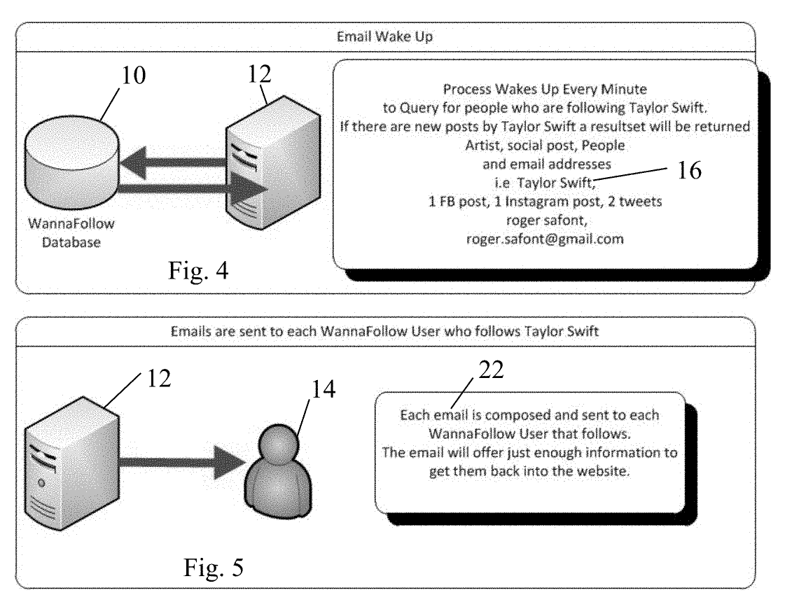

FIG. 4 shows the fourth step of the system and method. In step four, the local server 12 contacts the local database 10 to determine if the new post 20 should be shared with the Social Media Candidate 14. The local database 10 houses each Social Media Candidate's preferences regarding followees 16. If a followee 16 is associated with a Social Media Candidate and a new post 20 associated with the followee 16 is present in the local database 10 then, as shown in FIG. 5, a notification 22 is sent to the Social Media Candidate 14. The timing of these updates is determined by the Social Media Candidate when determining which followees to follow.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A method for aggregating and distributing social media messages, the method comprising:
storing in database a plurality of tables, the tables comprising:
a social media personality table, wherein the social media personality table comprises a mapping of a social media personality to a plurality of social media data feeds;
a social media personality posts table, wherein the social media personality posts table comprises a mapping of social media data feeds to a social media date stamp wherein the social media date stamp indicates the last update of the social media data feed and wherein a social media data feed comprises a social media network and a social media message; and
a social media follower table, wherein the social media follower table comprises a mapping of a social media user to at least one social media personality and for each social media personality, further comprises a mapping of the social media personality to a last updated social media message for each social media data feed mapped to the social media personality;
for each social media personality stored in the social media personality table, at a first predetermined interval, communicating via the Internet with the plurality of social media data feeds and determining if a new social media data is available based on the stored social media date stamp, and storing a new social media data when a new social media data is available; and
for each social media follower stored in the social media follower table, at a second predetermined interval, notifying via an email address the social media follower via an email address of all new social media data stored in the social media personality posts table for each social media personality, wherein a computer processor on a central computer server determines whether a social media data is a new social media data based on the social media date stamp.

2. A method for aggregating and distributing social media messages, the method comprising:
storing in a computer system a plurality of social media personalities, storing in a computer system a plurality of social media users;
at a first predetermined time interval, for each social media personality, gathering a plurality of social media messages associated with social media personality and storing the plurality of social media messages in a computer system; and
at a second predetermined time interval, for each social media user, notifying the social media user of all social media messages stored in the computer system based on a criteria identified by the social media user.

3. The method of claim 2 wherein the criteria identified by the social media user comprises a plurality of social media personalities for the social media user to follow.

4. The method of claim 2 wherein the criteria identified by the social media user comprises a time interval in which to be notified of social media updates.

5. The method of claim 2 wherein the criteria identified by the social media user comprises a mechanism in which to notify the social media user.

6. The method of claim 5 wherein the mechanism is email.

7. The method of claim 5 wherein the mechanism is a notification on a smartphone.

8. The method of claim 2 wherein storing in a computer system a plurality of social media personalities comprises storing in a relational database table a mapping of a social media personality to a plurality of social media data feeds.

9. The method of claim 2 wherein storing in a computer system a plurality of social media users comprises for each social media user storing in a relational database table a mapping of the social media user to a social media personality.

10. The method of claim 9 wherein storing in a computer system a plurality of social media personalities comprises storing in a relational database table a mapping of a social media personality to a plurality of social media data feeds.

11. The method of claim 10 wherein storing in a computer system a plurality of social media users further comprises storing a mapping of the social media personality to a last updated social media message for each social media data feed mapped to the social media personality.

12. The method of claim 2 wherein storing in a computer system a plurality of social media users comprises for each social media user storing in a relational database table a mapping of the social media user to a plurality of social media personalities.

13. A system for aggregating and distributing social media messages comprising:
a first database for storing a plurality of social media personalities;
a second database for storing a plurality of social media users; and
a central processor communicatively connected to the first database and the second database and configured to gather social media data feeds associated with each social media personality and further configured to notify each social media user of updated social media data feeds based on criteria identified by the social media user.
